(19) United States
(12) Patent Application Publication
(10) Pub. No.: US 2022/0069663 A1
(43) Pub. Date: Mar. 3, 2022

(54) MOTOR, AND INVERTER-INTEGRATED ROTATING ELECTRIC MACHINE

(71) Applicant: MITSUBISHI HEAVY INDUSTRIES ENGINE & TURBOCHARGER, LTD., Sagamihara-shi, Kanagawa (JP)

(72) Inventors: Takuma KONDO, Tokyo (JP); Hirofumi HIRATA, Tokyo (JP)

(73) Assignee: MITSUBISHI HEAVY INDUSTRIES ENGINE & TURBOCHARGER, LTD., Sagamihara-shi, Kanagawa (JP)

(21) Appl. No.: 17/420,948

(22) PCT Filed: Jan. 10, 2019
(86) PCT No.: PCT/JP2019/000492

§ 371 Date: Jul. 6, 2021

(51) Int. Cl. H02K 5/20; H02K 9/19; H02K 11/33

(52) U.S. Cl. CPC H02K 5/203; H02K 11/33; H02K 9/19

(57) ABSTRACT

A motor includes a motor body having a rotor that is rotatable around an axis and a stator that surrounds the rotor; a casing that has a cylinder portion and a an inverter box, the cylinder portion forming a cylindrical shape extending in an axial direction and surrounding the motor body, internally having a cooling water channel that extends in a C shape in a circumferential direction, and being used for allowing cooling water to flow, the inverter box overhanging on both sides of the cylinder portion in a tangential direction on an outer peripheral side of the cooling water channel in the cylinder portion; and an inverter that is housed in the inverter box and has a switching element disposed on a surface of the cylinder portion facing radially outward in the inverter box.

### TECHNICAL FIELD

The present invention relates to a motor and an inverter-integrated rotating electric machine.

### BACKGROUND ART

In the related art, automobiles including an inverter-integrated rotating electric machine (motor) are known, in which an inverter device is installed including a semiconductor stack in which a plurality of semiconductor elements are stacked. Since motors for driving such automobiles require a larger current and the temperature of the inverter tends to rise, the inverter cooling as shown in, for example, Patent Documents 1 and 2 is separated from a cooling portion of a motor body.

FIG. 10 shows the configuration of an inverter-integrated rotating electric machine 100 shown in Patent Document 1. The inverter-integrated rotating electric machine 100 has a stacked body 103 in which a plurality of semiconductor elements and a plurality of coolers for cooling the plurality of semiconductor elements are alternately stacked, and a pair of cooling water tanks 105 and 106 provided on both sides of the stacked body 103 along a stacking direction of the stacked body 103 to supply and drain the cooling water W to and from the plurality of coolers, and includes an inverter device in which the stacked body 103 and the pair of cooling water tanks 105 and 106 are installed in an external device, the cooling water tanks 105 and 106 being connected to a cooling water channel 104 that extends along the periphery of the motor body 101 and allowing the cooling water W to flow therethrough.

### CITATION LIST

### Patent Documents

### [Patent Document 1]

Japanese Patent No. 4327618

### [Patent Document 2]

Japanese Patent No. 6084421

### SUMMARY OF INVENTION

### Technical Problem

However, in the related-art motors as shown in the above-described Patent Documents 1 and 2, the inverter and the cooling portion of the motor body are separated from each other. Thus, the shape becomes complicated and the cooling flow channel becomes long. Therefore, a simple cooling structure was required.

The present invention has been made in view of the above-described problems, and an object of the present invention is to provide a motor capable of cooling both an inverter and a motor body with a simple configuration, and an inverter-integrated rotating electric machine.

### Solution to Problem

The present invention has adopted the following aspects in order to solve the above problems and achieve the above object.

(1) A motor according to one aspect of the present invention includes a motor body having a rotor that is rotatable around an axis and a stator that surrounds the rotor; a casing that forms a cylindrical shape extending in an axial direction and surrounding the motor body and has a cylinder portion and a housing portion, the cylinder portion internally having a flow channel that extends in a C shape in a circumferential direction, has a first end serving as an inflow port and a second end serving as an outflow port, and is used for allowing cooling water to flow, the housing portion overhanging on both sides of the cylinder portion in a tangential direction on an outer peripheral side of the flow channel in the cylinder portion; and an inverter that is housed in the housing portion and has a switching element disposed on a surface of the cylinder portion facing radially outward in the housing portion.

According to the motor of the above aspect, the motor body and the housing portion housing the inverter can be disposed in contact with the flow channel extending in a C shape in the circumferential direction. By sharing the cooling flow channel of the inverter with the cooling flow channel of the motor body in this way, the pipe shape can be simplified and a flow channel configuration having a simple structure that does not require a flow channel dedicated to the inverter is obtained. Therefore, both the inverter and the motor body can be efficiently cooled. For that reason, the present invention is suitable for, for example, a compressor motor for a fuel cell and an inverter-integrated rotating electric machine having a small amount of heat generation such as the inverter.

(2) In the motor according to the above (1), the inverter may be configured to be disposed in the vicinity of the inflow port on an upstream side of the flow channel.

According to such a configuration, since the inverter is disposed in the vicinity of the inflow port on the upstream side of the flow channel via the housing portion, the inverter can be cooled before the temperature of the fluid in the flow channel becomes high. Also, since the motor body is cooled by the entire flow channel in the circumferential direction, the inverter and the motor body can be efficiently cooled.

(3) In the motor according to the above (1) or (2), the motor body preferably includes an inflow joint that is connected to the inflow port and an inflow pipe for supplying the cooling water to the flow channel, and an outflow joint that is connected to the outflow port and an outflow pipe for discharging the cooling water from the flow channel.

In this case, since the inflow joint and the outflow joint are connected to the flow channel, a shape that uniformly spreads a flow to the flow channel in a short distance without causing pressure loss by using this joint portion can be obtained. For that reason, in the present invention, a related-art shape in which the inlet flow channel width of the flow channel is sharply spread by bending the inlet flow channel at 90° is not obtained. Thus, the pressure loss in the flow channel can be suppressed to improve the cooling efficiency. Since the cooling water can be uniformly spread in the axial direction in this way, it is possible to prevent the temperature of the motor body from rising locally.

(4) In the motor according to the above (3), a first pipe center line of the inflow joint and a second pipe center line of the outflow joint are preferably disposed so as to be offset from each other in the axial direction.

In this case, by disposing the pipe center lines of the joints so as to be offset from each other, the distance between the inflow port and the outflow port in the flow channel can be shortened. For that reason, the cooling water can be allowed to flow by disposing the flow channel such that the peripheral length thereof around the motor body is long, and the motor body can be more uniformly cooled. Additionally, in this case, the pressure loss can be further reduced by making the centers of the inflow port and the outflow port corresponding to the pipe center lines of the joint coincide with each other.

(5) In the motor according to the above (3) or (4), the inflow joint and the outflow joint may be gradually changed in cross section from end portions connected to the inflow pipe and the outflow pipe toward the inflow port and the outflow port so as to have flow channel cross-sectional shapes of the inflow port and the outflow port.

According to such a configuration, a shape is obtained in which the flow channel cross-sectional area changes at a constant rate from the inflow pipe and the outflow pipe in the pipelines of the inflow joint and the outflow joint. Thus, the pressure loss can be efficiently reduced.

(6) In the motor according to any one of the above (3) to (5), each of the inflow joint and the outflow joint may be divided in a direction along the pipe center line, and the divided pieces are coupled to each other by flanges provided at divided ends, and a guide vane may be provided inside at least one of the pair of flanges to be coupled.

According to such a configuration, since the guide vane is provided in the flange of each joint, the flow of the flow channel can be made more uniform.

(7) In the motor according to any one of the above (1) to (6), a portion where at least one of the inflow port and the outflow port and the flow channel are connected to each other at an acute angle may be connected with a curved surface.

According to such a configuration, the curved surface shape does not have an acute angle portion in the flow channel. Thus, the flow of the cooling water flowing in the flow channel and at least one of the inflow port and the outflow port can be made more uniform, and the pressure loss can be reduced.

(8) In the motor according to any one of the above (1) to (7), at least one of the first end and the second end in the flow channel may extend to a region between the inflow port and the outflow port.

According to such a configuration, it is possible to reduce a non-water channel section, and it is possible to obtain a shape in which the cooling water spreads over the entire circumference of the motor.

(9) The inverter-integrated rotating electric machine according to another aspect of the present invention includes the motor according to any one of the above (1) to (8).

According to the inverter-integrated rotating electric machine of the above aspect, similar to the above, by sharing the cooling flow channel of the inverter with the cooling flow channel of the motor body in this way, the pipe shape can be simplified and a flow channel configuration having a simple structure that does not require a flow channel dedicated to the inverter is obtained. Therefore, both the inverter and the motor body can be efficiently cooled. For that reason, the present invention is suitable for, for example, a compressor motor for a fuel cell and an inverter-integrated rotating electric machine having a small amount of heat generation such as the inverter.

### Advantageous Effects of Invention

According to the motors and the inverter-integrated rotating electric machine of the respective aspects of the present invention, both the inverter and the motor body can be cooled by a simple configuration.

### BRIEF DESCRIPTION OF DRAWINGS

FIG. 1 is a longitudinal sectional view of an inverter-integrated rotating electric machine including a motor according to a first embodiment of the present invention along a motor axis.

FIG. 2 is a view of a casing of the inverter-integrated rotating electric machine as viewed from line AA shown in FIG. 1 and is a longitudinal sectional view taken in a direction orthogonal to a motor axis.

FIG. 3 is a plan view of an inflow pipe and an outflow pipe as viewed from above.

FIG. 4 is an arrow view taken along line BB shown in FIG. 2 and a view in which the cross sections of a pipe axial direction divided at predetermined intervals are overlapped on each other.

FIG. 5 is a horizontal sectional view showing the inside of a joint portion of a cooling pipe.

FIG. 6 is a horizontal sectional view showing the inside of a protruding portion of the cooling pipe.

FIG. 7 is a longitudinal sectional view showing the configuration of a motor according to a second embodiment and is a view corresponding to FIG. 2.

FIG. 8 is a longitudinal sectional view showing the configuration of a motor according to a third embodiment and is a view corresponding to FIG. 2.

FIG. 9A is a side view of a cooling pipe according to a first modification example as viewed from the pipe axial direction and is a view corresponding to FIG. 4.

FIG. 9B is a side view of a cooling pipe according to a second modification example as viewed from the pipe axial direction and is a view corresponding to FIG. 4.

FIG. 10 is a longitudinal sectional view of a related-art inverter-integrated rotating electric machine taken in a direction orthogonal to a motor axis.

### DESCRIPTION OF EMBODIMENTS

Hereinafter, motors and an inverter-integrated rotating electric machine according to embodiments of the present invention will be described with reference to the drawings. Such embodiments show aspects of the present invention, do not limit the present invention, and can be optionally changed within the scope of the technical idea of the present invention.

### First Embodiment

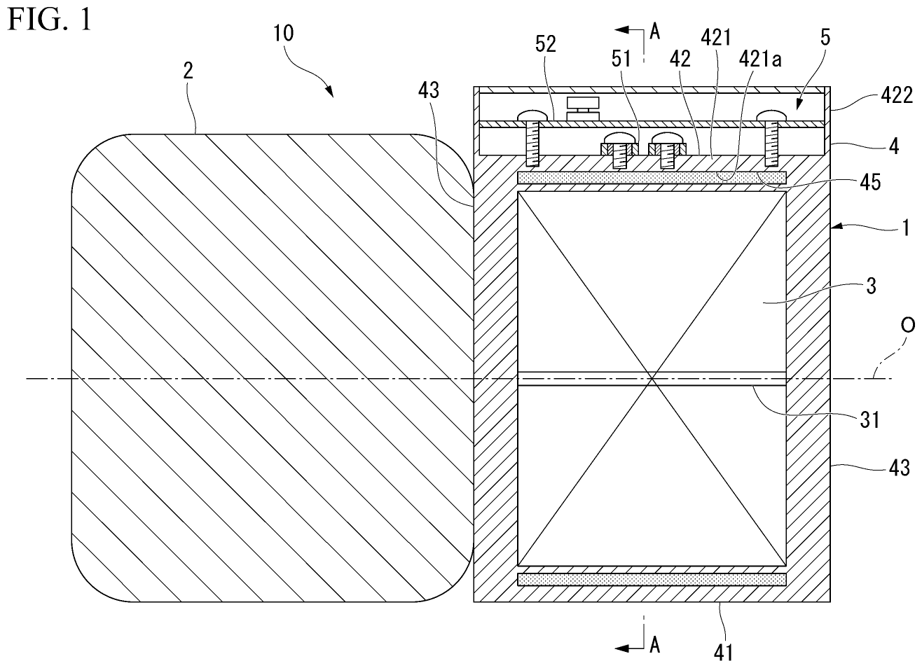

As shown in FIG. 1, a motor 1 according to the present embodiment is mounted on an inverter-integrated rotating electric machine 10 and is applied to, for example, a motor that drives a compressor for a fuel cell.

The inverter-integrated rotating electric machine 10 includes the motor 1 and a compressor 2 connected to the motor 1 and driven by the motor 1.

Here, in the present embodiment, a rotation center axis of the motor 1 is referred to as a motor axis O or an axis. Additionally, in plan view viewed from the direction of the motor axis O, a direction orthogonal to the motor axis O is referred to as a radial direction, and a direction orbiting around the motor axis O is referred to as a circumferential direction.

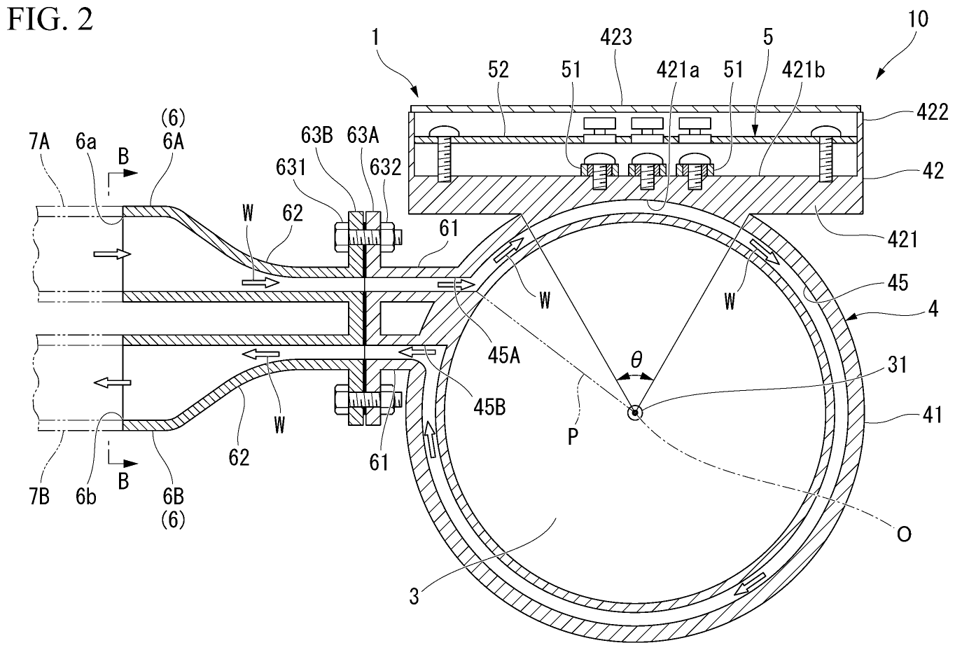

As shown in FIG. 2, the motor 1 includes a motor body 3 having a rotor (not shown) that is rotatable around the axis and a stator that surrounds the rotor; a casing 4 that forms a cylindrical shape extending in an axial direction and surrounding the motor body 3 and has a cylinder portion 41 and an inverter box 42 (housing portion), the cylinder portion 41 internally having a cooling water channel 45 (flow channel) that extends in a C shape in the circumferential direction and has a first end serving as an inflow port 45A and a second end serving as an outflow port 45B, and the inverter box 42 overhanging on both sides of the cylinder portion 41 in a tangential direction on an outer peripheral side of the cooling water channel 45 in the cylinder portion 41; and an inverter 5 that is housed in the inverter box 42 and has a switching element disposed on a surface (an upper surface 421b of a bottom wall 421 of the inverter box 42, which will be described below) of the cylinder portion 41 facing radially outward in the inverter box 42.

The cylinder portion 41 and the inverter box 42 are integrally formed. The inverter box 42 is disposed on an upper portion of the cylinder portion 41 in a state in which the motor 1 is installed.

The cylinder portion 41 has an opening formed in a part in the circumferential direction and has a substantially C shape as seen from the axial direction as described above. Joints 6 (6A, 6B) are connected to the inflow port 45A and the outflow port 45B at an open end of the cylinder portion 41. Here, an inflow joint 6A is connected to the inflow port 45A, and an outflow joint 6B is connected to the outflow port 45B. The inflow opening 6a of the inflow joint 6A is connected to an inflow pipe 7A (two-dot chain line in FIG. 2), and the outflow opening 6b of the outflow joint 6B is connected to an outflow pipe 7B (two-dot chain line in FIG. 2).

The inverter box 42 includes a rectangular plate-shaped bottom wall 421, a side wall 422 erected over the entire outer peripheral edge of the bottom wall 421, and a detachable lid 423 that covers an opening surrounded by the side wall 422. The bottom wall 421 is disposed such that a bottom surface 421a of bottom wall 421 is in a tangential direction and is a horizontal direction to the top of the outer peripheral surface 41a of the cylinder portion 41.

The inverter 5 housed in the inverter box 42 has a plurality of power transistors 51 (switching elements) and a substrate 52. A connection point of each power transistor 51 is connected to a phase end of each phase coil of the motor body 3.

The substrate 52 is provided so as to divide the inside of the inverter box 42 into upper and lower portions.

The switching operation of the power transistor 51 is controlled by a control unit (not shown). That is, the control unit controls the inverter 5 so as to generate a torque according to a motor torque command in the motor body 3.

As shown in FIG. 1, end covers 43 are provided in the casing 4 at both end portions of the cylinder portion 41 in the direction of the motor axis O. The end cover 43 supports a rotating shaft 31 of the motor body 3 to which the rotor is fixed so as to be rotatable around the axis.

A cooling water channel 45 for cooling the motor body 3 and the inverter 5 is formed inside the cylinder portion 41 of the casing 4. That is, the motor body 3 is directly cooled from the cylinder portion 41 over the entire circumferential direction, and the inverter 5 is cooled from the cylinder portion 41 via the bottom wall 421 of the inverter box 42. As shown in FIG. 2, the inverter box 42 has a central portion of the bottom wall 421 in a width direction (the direction orthogonal to the axial direction in a top view) connected to the cylinder portion 41.

The casing 4 can be manufactured of any material having stiffness, such as metal, polymer, and ceramics.

The motor body 3 includes the rotating shaft 31 (refer to FIG. 1). The motor body 3 has a rotor (not shown) that rotationally moves in conjunction with the rotating shaft 31 and a stator (not shown) that is fixed to the casing 4.

Next, as shown in FIG. 2, a cooling water channel 45 through which cooling water W for cooling the motor body 3 and the inverter 5 flows is provided in the cylinder portion 41 along the circumferential direction of the cylinder portion 41. That is, the cross-section width direction of the cooling water channel 45 extends along the axial direction (refer to FIG. 1). The cooling water channel 45 has an opening formed in a part in the circumferential direction and has a substantially C shape as seen from the axial direction as described above. The inflow joint 6A for the cooling water W is connected to one inflow port 45A located at the open end of the cooling water channel 45, and the outflow joint 6B for the cooling water W is connected to the other outflow port 45B.

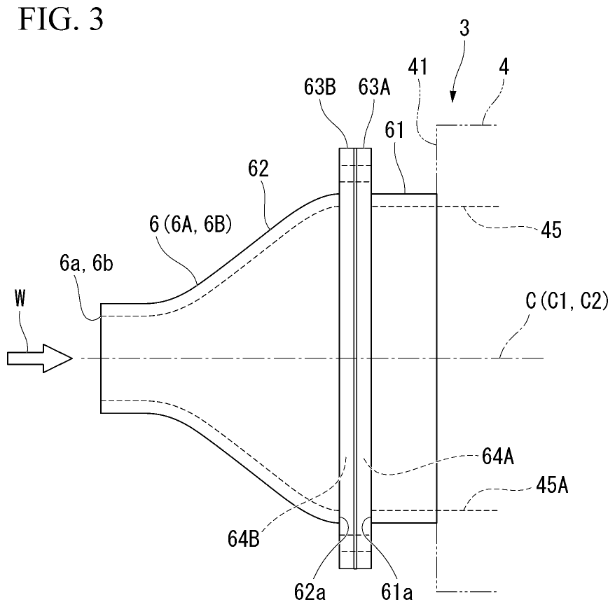

As shown in FIGS. 2 and 3, the joints 6 (inflow pipe 6A and outflow pipe 6B) have protruding portions 61 that are integrally provided in a state in which the protruding portions 61 protrude from the openings (inflow port 45A and outflow port 45B) of the cylinder portion 41 of the casing 4, and joint portions 62 coupled to the protruding portions 61 via flanges 63A and 63B. That is, the joints 6 are divided into the protruding portions 61 and the joint portions 62 and these portions are coupled to each other by the flanges 63A and 63B.

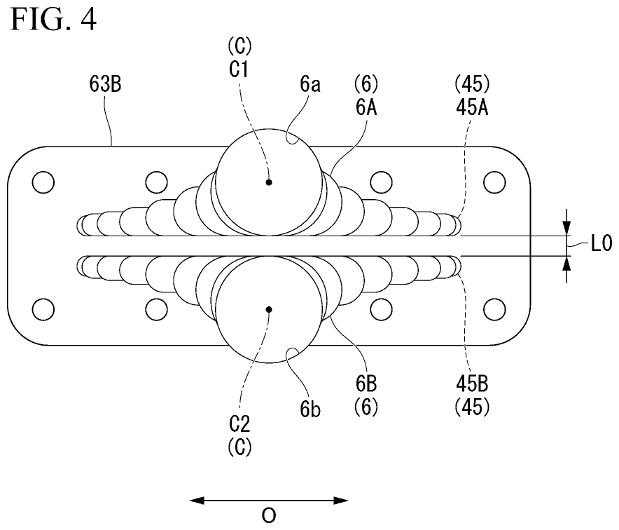

The protruding portions 61 of the inflow joint 6A and the outflow joint 6B are the same width dimension as the length of the cooling water channel 45 in the axial direction as seen from the direction (pipe center lines C (C1, C2)) orthogonal to opening surfaces, and the pipe center lines C1 and C2 thereof extend parallel to each other (refer to FIG. 4). The first flange 63A is formed at a protruding end 61a of the protruding portion 61.

As shown in FIGS. 3 and 4, the cross sections of the joint portions 62 of the inflow joint 6A and the outflow joint 6B gradually change from the end portions 6a and 6b connected to the inflow pipe 7A and the outflow pipe 7B toward the inflow port 45A and the outflow port 45B so as to have the flow channel cross-sectional shape of the inflow port 45A and the outflow port 45B as shown in FIG. 2.

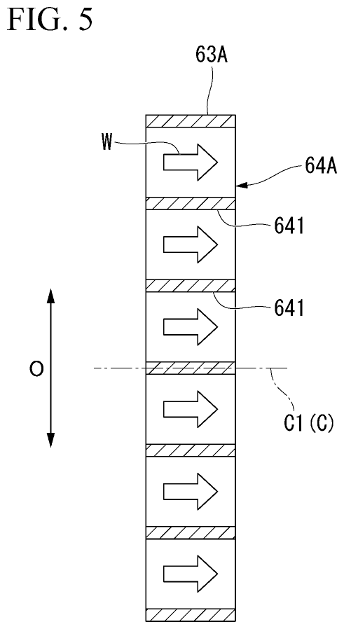

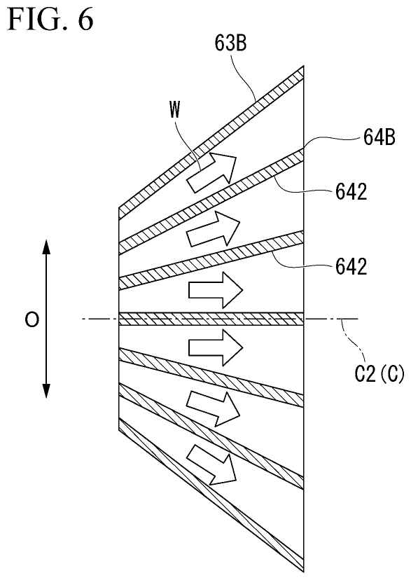

As shown in FIGS. 5 and 6, a plurality of guide vanes 64 (64A, 64B) are formed inside each of the first flange 63A of the protruding portion 61 and the second flange 63B of the joint portion 62.

As shown in FIG. 5, the first guide vane 64A provided in the first flange 63A has a plurality of first guides 641 that extend in a direction along the first pipe center line C1 and are arranged in parallel in the axial direction (motor axis O). As shown in FIG. 6, the second guide vane 64B provided in the second flange 63B has a plurality of second guides 642 that are arranged so as to gradually spread radially from the inflow and outflow pipes 7A and 7B side (refer to FIG. 2) toward the inflow and outflow ports 45A and 45B.

As shown in FIG. 2, the cooling water W is supplied from the inflow joint 6A to the cooling water channel 45, flows through the cooling water channel 45 from the inflow port 45A side to the outflow port 45B side to cool the inverter 5 and the motor body 3, and is discharged to the outflow joint 6B. That is, the cooling water W flows through the cooling water channel 45, thereby absorbing the heat of the inverter 5 and the motor body 3, and performs heat exchange of cooling the inverter 5 and the motor body 3 to exhibit high temperature, and is discharged from the outflow joint 6B. In addition, the cooling water W of which the temperature has risen radiates heat by a radiator or the like (not shown) and is returned to a water supply tank (not shown).

The inverter 5 housed in the inverter box 42 is disposed in the vicinity of the inflow port 45A of the cooling water channel 45, that is, on the upstream side of the cooling water W flowing through the cooling water channel 45. For that reason, the inverter 5 is cooled in a state in which the temperature of the cooling water W is lower than that in the vicinity of the outflow port 45B. Meanwhile, the motor body 3 is cooled in the entire cooling water channel 45.

Here, as the preferred range of a cooling region of the inverter 5, a contact region (inverter cooling angle θ) of the inverter box 42 with the cylinder portion 41, when a flow channel start point P, which is the position of the inflow port 45A with respect to the motor axis O, is set to 0°, for example as shown in FIG. 2 as seen from the axial direction, an angle directed to the downstream side from a flow channel start point P is preferably 20 to 90°.

Next, the actions of the motor 1 having the above-described configuration and the inverter-integrated rotating electric machine 10 using the motor 1 will be specifically described with reference to the drawings.

As shown in FIG. 2, in the present embodiment, the motor body 3 and the inverter box 42 housing the inverter 5 can be disposed in contact with the cooling water channel 45 extending in a C shape in the circumferential direction. By sharing the cooling flow channel 45 of the inverter 5 with the cooling flow channel 45 of the motor body 3 in this way, the pipe shape can be simplified and a flow channel configuration having a simple structure that does not require a flow channel dedicated to the inverter is obtained. Therefore, both the inverter 5 and the motor body 3 can be efficiently cooled. For that reason, the present invention is suitable for the compressor motor for a fuel cell as in the present embodiment and the inverter-integrated rotating electric machine 10 having a small amount of heat generation such as the inverter.

Additionally, in the present embodiment, since the inverter 5 is disposed in the vicinity of the inflow port 45A on the upstream side of the cooling water channel 45 via the inverter box 42, the inverter 5 can be cooled before the temperature of the cooling water W in the cooling water channel 45 becomes high. Also, since the motor body 3 is cooled by the entire cooling water channel 45 in the circumferential direction, the inverter 5 and the motor body 3 can be efficiently cooled.

Additionally, in the present embodiment, since the inflow joint 6A and the outflow joint 6B are connected to the cooling water channel 45, a shape that uniformly spreads a flow to the cooling water channel 45 in a short distance without causing pressure loss by using this joint portion can be obtained. For that reason, in the present embodiment, a related-art shape in which the inlet flow channel width of the flow channel is sharply spread by bending the inlet flow channel at 90° is not obtained. Thus, the pressure loss in the cooling water channel 45 can be suppressed to improve the cooling efficiency.

Since the cooling water W can be uniformly spread in the axial direction in this way, it is possible to prevent the temperature of the motor body 3 from rising locally.

Additionally, in the present embodiment, the inflow joint 6A and the outflow joint 6B are gradually changed in cross section from the end portions 6a and 6b connected to the inflow pipe 7A and the outflow pipe 7B toward the inflow port 45A and the outflow port 45B so as to have flow channel cross-sectional shapes of the inflow port 45A and the outflow port 45B. Thus, shapes of the inflow joint 6A and the outflow joint 6B have the flow channel cross-sectional area that changes at a constant rate from the inflow pipe 7A and the outflow pipe 7B in the pipelines of the inflow joint 6A and the outflow joint 6B. As a result, the pressure loss can be efficiently reduced.

Additionally, in the present embodiment, each of the inflow joint 6A and the outflow joint 6B is divided in a direction along each of the pipe center lines C1 and C2, and the divided pieces are coupled to each other by flanges 63A and 63B provided at the divided ends. Then, as shown in FIGS. 5 and 6, since the guide vanes 64A and 64B are provided inside the pair of flanges 63A and 63B to be coupled, the flow of the cooling water channel 45 can be further made uniform.

In the motor 1 according to the above-described present embodiment, both the inverter 5 and the motor body 3 can be cooled by a simple configuration, and the pressure loss in the cooling water channel 45 can be suppressed to improve the cooling efficiency.

### Second Embodiment

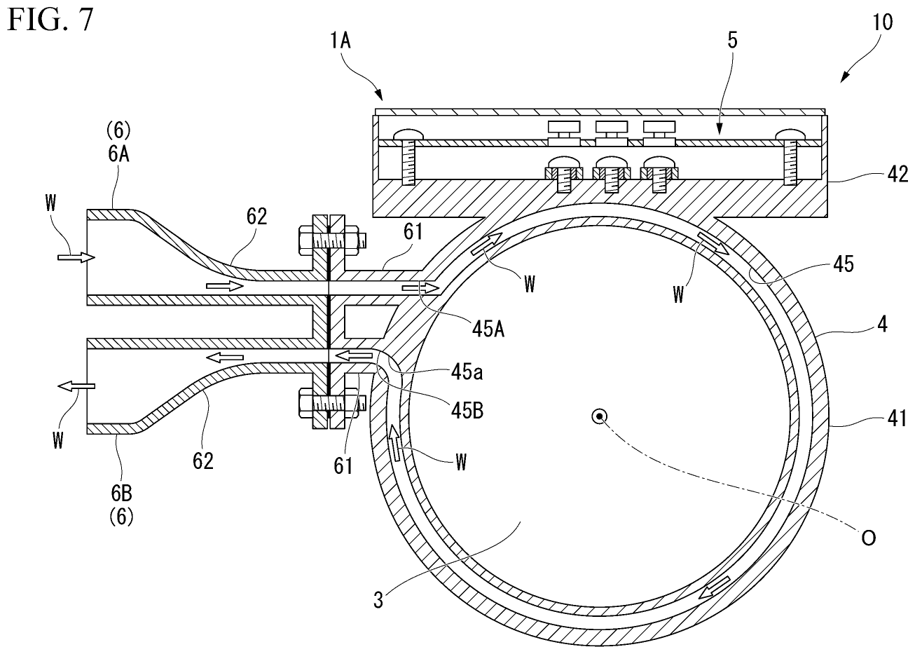

Next, as shown in FIG. 7, a motor according to a second embodiment is configured to be connected with a curved surface 45a having an R shape at a portion where the outflow port 45B connected to the protruding portion 61 of the joint 6 of the cooling water channel 45 and the cooling water channel 45 are connected to each other at an acute angle.

In the second embodiment, since the cooling water channel 45 has a curved surface shape that does not have an acute angle portion, the flow of the cooling water W flowing between the inside of the cooling water channel 45 and the outflow port 45B can be made more uniform, and the pressure loss can be reduced.

### Third Embodiment

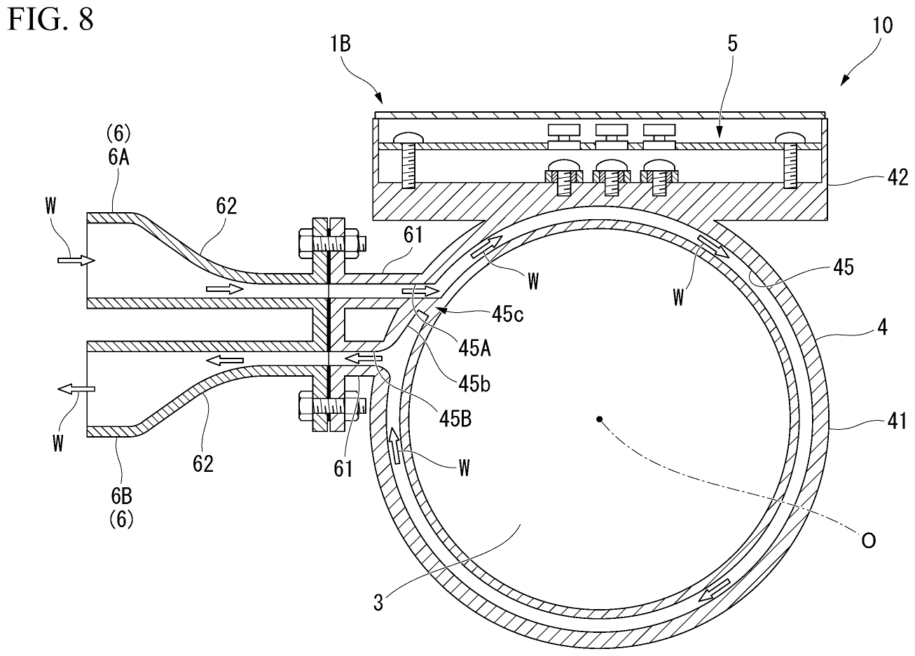

Next, as shown in FIG. 8, a motor according to a third embodiment has a configuration in which an extension portion 45b extending to a region between the inflow port 45A and the outflow port 45B in the cooling water channel 45 is formed.

Accordingly, it is possible to reduce a non-water channel section (a region of reference numeral 45c) of the cooling water channel 45, and it is possible to obtain a shape in which the cooling water W spreads over the entire circumference of the motor body 3.

### Modification Examples

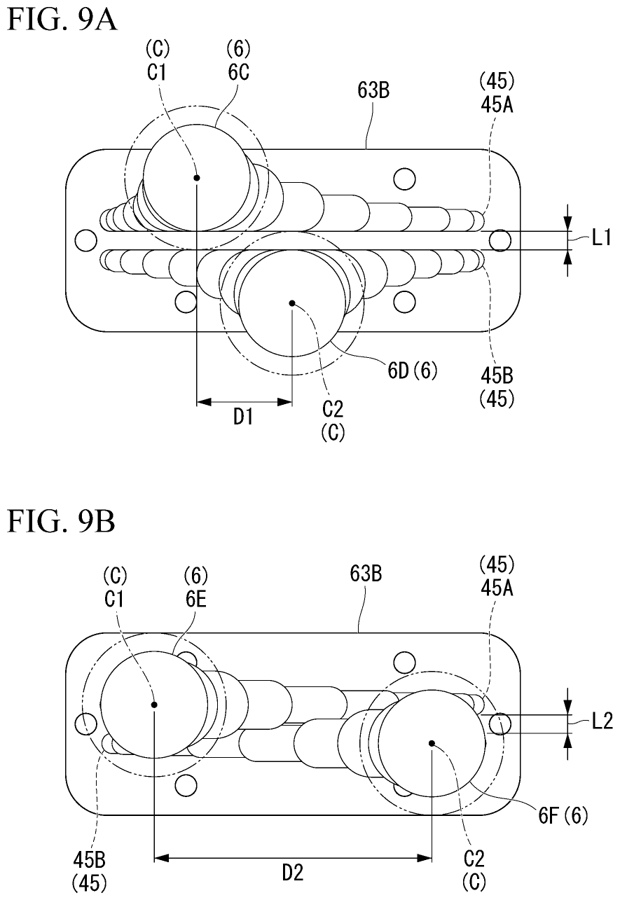

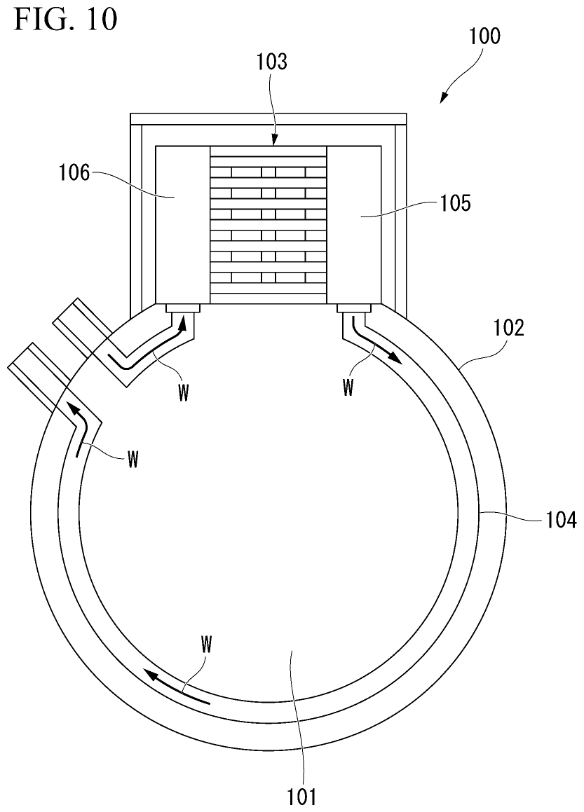

Next, in a first modification example shown in FIG. 9A and a second modification example shown in FIG. 9B, the shape of the joint is changed. In the present modification example, the first pipe center line C1 of the inflow joints 6C and 6E and the second pipe center line C2 of the outflow joints 6D and 6F are disposed so as to be offset from each other in the axial direction (left and right directions of FIGS. 9A and 9B).

As shown in FIG. 9A, the first modification example has a configuration in which only the inflow joint 6C is offset with respect to the outflow joint 6D by a distance of reference numeral D1 in the axial direction. In this case, a distance L1 between the inflow port 45A and the outflow port 45B in the cooling water channel 45 is made shorter than a distance L0 (refer to FIG. 4) of the above-described embodiment.

As shown in FIG. 9B, the second modification example has a configuration in which both the inflow joint 6E and the outflow joint 6F are offset from each other by a distance of reference numeral D2 in the axial direction so as to be separated from each other by the longest distance. In this case, a distance L2 between the inflow port 45A and the outflow port 45B in the cooling water channel 45 is further shortened compared with the distance L1 (refer to FIG. 9A) of the above-described second modification example.

By offsetting the pipe center lines C1 and C2 of the inflow joints 6C and 6E and the outflow joints 6D and 6F in this way, the distance between the inflow port 45A and the outflow port 45B in the cooling water channel 45 can be shortened. For that reason, the cooling water W can be allowed to flow by disposing the cooling water channel 45 such that the peripheral length thereof around the motor body 3 is long, and the motor body 3 can be more uniformly cooled.

Additionally, in this case, the pressure loss can be further reduced by making the centers of the inflow port 45A and the outflow port 45B corresponding to the pipe center lines C1 and C2 of the joints 6 coincide with each other.

Although the embodiments of the motor and the inverter-integrated rotating electric machine according to the present invention have been described above, the present invention is not limited to the above embodiments and can be appropriately changed without departing from the spirit of the present invention.

For example, in the present embodiment, the inverter box 42 housing the inverter 5 is configured to be disposed on the upstream side of the cooling water channel 45 in the vicinity of the inflow port 45, but the position of the inverter box 42 is not limited to this position. For example, the cooling position of the inverter 5 in the cooling water channel 45 may be a central portion in an extension direction of the cooling water channel 45 in the circumferential direction.

Additionally, in the present embodiment, the inflow joint 6A and the outflow joint 6B are configured to be connected to the cooling water channel 45 of the cylinder portion 41 of the motor body 3, but the joints 6A and 6B may be configured to be omitted. In this case, the inflow port 45A and the outflow port 45B of the cooling water channel 45 are connected to the inflow pipe 7A and the outflow pipe 7B.

Additionally, in the present embodiment, the cross sections of the inflow joint 6A and the outflow joint 6B gradually change from the end portions 6a and 6b toward the inflow port 45A and the outflow port 45B so as to have the flow channel cross-sectional shape of the inflow port 45A and the outflow port 45B, but are not limited to being such a shape.

Moreover, each of the inflow joint 6A and the outflow joint 6B is divided in a direction along each of the pipe center lines C1 and C2 and the divided pieces are coupled to each other by the flanges 63A and 63B provided at the divided ends, but are not limited to having such a divided structure and may be integrally provided.

Additionally, in the present embodiment, the guide vanes 64A and 64B are provided inside the pair of flanges 63A and 63B that couple the divided joints 6 to each other, but the guide vanes 64A and 64B may be provided inside at least one of the pair of flanges 63A and 63B, or the guide vanes may be omitted.

In the above-described second embodiment, the portion where the outflow port 45B of the cooling water channel 45 and the cooling water channel 45 are coupled to each other at an acute angle is connected with the curved surface. However, as long as the inflow port 45A is connected at an acute angle, the inflow port 45A side may be connected with a curved surface.

In addition, it is possible to appropriately replace the components in the above-described embodiments with known components without departing from the spirit of the present invention, and the above-described embodiments may be appropriately combined.

### INDUSTRIAL APPLICABILITY

According to the motor and the inverter-integrated rotating electric machine of the present invention, both the inverter and the motor can be cooled by a simple configuration, and the pressure loss in the flow channel can be suppressed to improve the cooling efficiency.

### REFERENCE SIGNS LIST

1: Motor
2: Compressor
3: Motor body
4: Casing
5: Inverter
6: Cooling joint
6A: Inflow joint
6B: Outflow joint
7A: Inflow pipe
7B: Outflow pipe
10: Inverter-integrated rotating electric machine
31: Shaft
41: Cylinder portion
42: Inverter box (housing portion)
45: Cooling water channel (flow channel)
51: Power transistor (switching element)
61: Protruding portion
62: Joint portion
63A, 63B: Flange
O: Motor axis
W: Cooling water

1. A motor, comprising:
a motor body having a rotor that is rotatable around an axis and a stator that surrounds the rotor;
a casing that has a cylinder portion and a housing portion, the cylinder portion forming a cylindrical shape extending in an axial direction and surrounding the motor body, internally having a flow channel that extends in a C shape in a circumferential direction, having a first end serving as an inflow port and a second end serving as an outflow port, and being used for allowing cooling water to flow, the housing portion overhanging on both sides of the cylinder portion in a tangential direction on an outer peripheral side of the flow channel in the cylinder portion; and
an inverter that is housed in the housing portion and has a switching element disposed on a surface of the cylinder portion facing radially outward in the housing portion.

2. The motor according to claim 1,
wherein the inverter is disposed in a vicinity of the inflow port on an upstream side of the flow channel.

3. The motor according to claim 1,
wherein the motor body includes an inflow joint that is connected to the inflow port and an inflow pipe for supplying the cooling water to the flow channel, and an outflow joint that is connected to the outflow port and an outflow pipe for discharging the cooling water from the flow channel.

4. The motor according to claim 3,
wherein a first pipe center line of the inflow joint and a second pipe center line of the outflow joint are disposed so as to be offset from each other in the axial direction.

5. The motor according to claim 1,
wherein the inflow joint and the outflow joint are gradually changed in cross section from end portions connected to the inflow pipe and the outflow pipe toward the inflow port and the outflow port so as to have flow channel cross-sectional shapes of the inflow port and the outflow port.

6. The motor according to claim 3,
wherein each of the inflow joint and the outflow joint are divided in a direction along the pipe center line, and the inflow joint and the outflow joint are coupled to each other by flanges provided at divided ends, and
a guide vane is provided inside at least one of the pair of flanges to be coupled.

7. The motor according to claim 1,
wherein a portion where at least one of the inflow port and the outflow port and the flow channel are connected to each other at an acute angle is connected with a curved surface.

8. The motor according to claim 1,
wherein at least one of the first end and the second end in the flow channel extends to a region between the inflow port and the outflow port.

9. An inverter-integrated rotating electric machine, comprising:
the motor according to claim 1.

10. The motor according to claim 5,
wherein each of the inflow joint and the outflow joint are divided in a direction along the pipe center line, and the inflow joint and the outflow joint are coupled to each other by flanges provided at divided ends, and
a guide vane is provided inside at least one of the pair of flanges to be coupled.
